(19) United States
(12) Patent Application Publication
(10) Pub. No.: US 2025/0369138 A1
(43) Pub. Date: Dec. 4, 2025

(54) OPERATING AN ELECTROLYSIS CELL

(71) Applicant: Siemens Energy Global GmbH & Co. KG, München (DE)

(72) Inventors: Sven Schumann, Wilhermsdorf (DE); Moritz Benninghoff, Mülheim an der Ruhr (DE)

(21) Appl. No.: 18/874,174

(22) PCT Filed: Jun. 21, 2023
(86) PCT No.: PCT/EP2023/066888

§ 371 Date: Dec. 12, 2024

(30) Foreign Application Priority Data
Jul. 6, 2022 (DE) 10 2022 206 877.7

(51) Int. Cl. C25B 15/023; C25B 9/65; C25B 9/70

(52) U.S. Cl. CPC C25B 15/023; C25B 9/65; C25B 9/70

(57) ABSTRACT

A method for operating an electrolysis cell, to which an electrical electrolysis current is supplied in normal operation, in order to carry out an electrolysis of a substance arranged in a reaction chamber of the electrolysis cell is provided. The method includes a direct current being supplied as individual protective current to the electrolysis cell in an operating state different from normal operation. The invention addresses the problem of reducing the outlay for an improved protective function to avoid fuel cell operation of a particular electrolysis cell. According to the invention a clocked direct current is supplied to the electrolysis cell as the individual protective current.

### BACKGROUND

The invention relates to a method for operating an electrolysis cell, to which an electrical electrolysis current is supplied in normal operation, in order to carry out an electrolysis of a substance arranged in a reaction chamber of the electrolysis cell, a direct current being supplied as individual protective current to the electrolysis cell in an operating state different from normal operation. The invention furthermore relates to a protective unit for an electrolysis cell, wherein the electrolysis cell is formed so that it is supplied with an electrical electrolysis current in normal operation in order to perform an electrolysis of a substance arranged in a reaction chamber of the electrolysis cell, with at least two terminal fittings for electrically fitting to electrodes of the electrolysis cell, at least two connection terminals for electrically connecting to an electrical energy source, a controllable electrical energy converter electrically coupled to the at least two connection terminals and the terminal fittings which is formed to supply the electrolysis cell with a direct current as the individual protective current in an operating state different from normal operation. Furthermore, the invention relates to a protective apparatus for an electrolysis device having a plurality of electrolysis cells electrically connected in series, with a plurality of protective units, wherein each one of the electrolysis cells is electrically coupled with a respective protective unit, at least one electrical energy source for supplying the protective units with electrical energy, and a control unit for individually controlling the protective units. Finally, the invention also relates to an electrolysis device with a plurality of electrolysis cells electrically connected in series and a protective apparatus electrically coupled with the electrolysis cells.

Electrolysis devices, protective apparatuses, protective units for protective apparatuses and methods for operating electrolytic cells are well known in the state of the art, so that there is basically no need for separate printed evidence for this. Generic electrolysis cells and electrolysis devices, in particular for the electrolysis of water to hydrogen and oxygen, are well known in the state of the art, for example from DE 197 29 529 C1. The general function of electrolysis, in particular water electrolysis, is known to the skilled person, which is why detailed explanations are not given here.

Electrolysis devices which have a single, but in particular a plurality of electrolysis cells, which are generally at least partially electrically connected in series, serve, among other things, to produce substances which can preferably be used on an industrial scale, such as hydrogen for a water electrolysis, carbon monoxide for a carbon dioxide electrolysis or the like. For this purpose, a suitable small electrical direct voltage is supplied to at least two electrodes of a particular electrolysis cell which can be in the range from a few volts or possibly even smaller than one volt. A corresponding electrical direct current is provided as electrolysis current by an electrolysis energy source corresponding to the amount of substance to be provided by the electrolysis. In case of electrolysis cells connected in series, this direct current flows through all of the battery cells connected in series. The series connection is electrically coupled with the electrolysis energy source. In principle, however, it is also possible to connect electrolysis cells not only in series, but also at least partially in parallel.

In particular in aqueous electrolysis, such as chlorine/alkali electrolysis, PEM electrolysis or the like, a membrane is often provided which separates particular reaction chambers of particular reaction areas of a particular electrolysis cell in which particular electrodes are arranged. Often, a catalyst is arranged on such a membrane in order to enable or accelerate the process of electrolysis. Electrolysis is generally caused in that the electrodes of a particular electrolysis cell in normal operation are supplied with the electrolysis current or a suitable electrical direct voltage, also referred to as cell voltage.

What proves to be at least partially critical for a particular electrolysis cell is, among other things, a transition from or to an operating state that is different from the normal operating state. This relates, in particular, to a start up of the electrolysis cell or the electrolysis device and a shut down of the electrolysis cell or the electrolysis device. Particularly when shutting down after normal operation, residual substances, in particular residual gases, can still be present in the electrolysis cell, which can, under certain circumstances, lead to the electrolysis cell being able to show fuel cell functionality. However, this can irreversibly damage the electrolysis cell, which is why the fuel cell functionality should be avoided at all costs. For this purpose, it is known to supply the electrolysis cell with a protective voltage, also called polarization voltage, outside of normal operation, which is chosen so that the fuel cell functionality can be largely avoided. For an electrolysis cell for electrolyzing water, the protective voltage can be about 1.25 V, for example. As soon as the electrolysis cell is correspondingly cooled down and residual gases are removed, providing the protective voltage can be deactivated.

It has been shown that electrolysis cells age differently from one another and/or can have characteristics deviating from one another. This can prove to be particularly problematic when electrolysis cells are connected in series if the protective voltage is to be provided by a voltage supplied to the series connection. Due to the different ageing or characteristics, the case can occur where the voltage supplied to the series connection is not equally distributed to all cells connected in series. Therefore, it is then required to choose the electrical voltage of the series connection to be so large that the protective voltage can still reliably be achieved for the most unfavorable electrolysis cell. However, this also causes the other cells to be supplied with a correspondingly high voltage which can be significantly larger than the protective voltage so that these are further operated in electrolysis operation. Therefore, in order to avoid an explosive mixture in these electrolysis cells, it is common to purge with nitrogen.

It is further known from EP 3 982 501 A1 to individually supply each electrolysis cell with a protective voltage. However, providing the particular protective voltages for the electrolysis cells and the substantially constant direct currents connected herewith proves to be comparably complex.

The invention addresses the problem of reducing the outlay for an improved protective function to avoid fuel cell operation of a particular electrolysis cell. Further, the invention addresses the problem of indicating a corresponding method, a corresponding protective apparatus and a corresponding electrolysis device.

### SUMMARY

With regard to a generic method, the invention in particular proposes that a clocked direct current is supplied to the electrolysis cell as the individual protective current.

With regard to a generic protective unit, the invention in particular proposes that the energy converter is formed to supply a clocked direct current as the individual protective current to the electrolysis cell.

With regard to a generic protective apparatus, the invention in particular proposes that the protective units are formed according to the invention.

With regard to a generic electrolysis device, the invention in particular proposes that the protective apparatus is formed according to the invention.

Among others, the invention is based on the thought that the electrolysis cells do not have to be supplied with a constant direct current during operation different from normal operation. Taking into account an electrical capacity of a particular electrolysis cell, it is also possible to reach the desired function with a clocked direct current or a pulsed direct current. A clocked direct current means that an amplitude is not constant, but there is no polarization change with regard to the direct current. In particular, it can be provided that a current-controlled clocked direct current is supplied to particular one of the electrolysis cells. This makes it possible to identify with a detected electrical voltage as the cell voltage at the particular electrolysis cell whether the protective voltage is reached. For this purpose, a corresponding sensor unit can be provided, which is also electrically coupled to the electrodes of the particular electrolysis cell. The invention is based on the thought, among others, that the electrolysis cell can electrically behave like an electrical capacity. Thus, by setting the clocked direct current, the desired protective function can be realized in a simple manner. It proves to be advantageous that an exact regulation of the protective voltage and a corresponding provision of a constant direct current are not required. This is in particular advantageous for the effort of providing the direct current. In particular, complex smoothing units on the direct current side can be reduced or even avoided.

The clocked direct current can have a specified or specifiable frequency or clock rate. In one embodiment, specified or specifiable frequency or clock rate means here that the frequency or clock rate is substantially constant at least for a specified plurality of clock periods corresponding to the specification. The frequency or clock rate can be specified, among others, depending on a minimum or mean detected electrical cell voltage, a specified minimum electrical cell current, a specified mean cell current and/or the like. For example, the clocked direct current reaches the value zero in at least one clock break. The clocked direct current can have a specified or specifiable duty cycle. It can be provided that the duty cycle is set depending on the cell voltage. In one embodiment, the clocked direct current has a substantially fixed frequency.

The cell voltage is an electrical voltage between at least two electrodes of the electrolysis cell. The cell voltage can be detected continuously or in a time-discrete manner. The detected cell voltage can be averaged. The cell voltage can, for example, also be detected in a clock break only or during a current impulse of the clocked direct current. In one embodiment, when detecting the cell voltage, it is at the same time also detected whether the detection takes place during the clock break or the current impulse.

In one embodiment, the electrolysis cell is a PEM electrolysis cell. The PEM electrolysis cell is a cell which has a proton exchange membrane, often also called polymer electrolyte membrane (PEM). The PEM is a semi-permeable membrane generally made from ionomer. PEMs are permeable to protons while the transport of gases such as oxygen or hydrogen is substantially prevented. PEMs are either made from pure polymer or from composite membranes where other materials are integrated in a polymer matrix, for example. A commercially available PEM is Nafion of the chemical company DuPont, for example. PEM electrolysis cells have the advantage, in particular compared to alkaline electrolysis cells, that leakage resistances can be significantly smaller. As a result, not only can a high efficiency be achieved compared to alkaline electrolysis cells, but a large area-specific time constant can also be achieved in comparison to alkaline electrolysis cells. Large time constants can therefore be achieved with PEM electrolysis cells, in particular with regard to electrical parameters such as cell voltage and cell current. This can affect a setting of the clocked direct current.

Thus, the invention also makes it possible to significantly simplify an individual supply of the electrolysis cells. At the same time, the advantages which can be achieved with the individual supply of the electrolysis cells can furthermore be realized. Overall, the effort and also the costs associated therewith can be reduced. It proves to be particularly advantageous that the invention does not require the protective units to be individually supplied with their own energy supply. Rather, the protective units can also be supplied from a shared energy source. Furthermore, the invention enables to integrate the detection of the electrical voltage of a particular electrolysis cell in the function of the provision of the clocked direct current so that a voltage measurement can be achieved with lower effort.

Furthermore, it was found with the invention that the use of a clocked direct current does not have a significant influence on the aging of the particular electrolysis cell. Overall, this can achieve that effort and costs can be reduced and at the same time the protective function for avoiding a fuel cell operation can be improved.

Furthermore, the invention allows to be able to individually set the individual protective current for every electrolysis cell. Thus, in particular an ageing or a cell-specific characteristic of the particular electrolysis cell can be considered as well.

The protective unit may be an electronic circuit or hardware circuit which is supplied with electrical energy from the electrical energy source. The electrical energy source can have a direct current source or the like, for example. The electrical energy source can be formed for energy supply for more than one single protective unit. But the electrical energy source can also be formed individually for supply for exactly one single protective unit. For this, it can be integrated at least partially in the protective unit, for example. The electrical energy source can use electrical energy from a public energy supply network or an electrical energy storage, for example.

In one embodiment, the protective unit is supplied with an electrical voltage of the electrical energy source so that it therefore provides the particular protective current in the form of a clocked direct current. The protective unit may be provided individually for every electrolysis cell and electrically coupled to it. But it can also be provided that the protective unit supplies two or more electrolysis cells, in particular connected in parallel, with the protective current.

The clocked direct current can be chosen as the protective current for an electrolysis of water in a range, for example, so that an electrical voltage on the electrolysis cell of about 1.35 V to about 1.45 V sets as a cell voltage. In one embodiment, the voltage is larger than 1.25 V. An operating voltage in normal operation of the electrolysis is generally significantly larger than the protective voltage or the voltage which is achieved with the protective current. In normal electrolysis operation, the operating voltage at a particular electrolysis cell at the electrolysis of water can be about 1.9 V. With suitable electrolytes and/or catalysts, this voltage can under certain circumstances also only be about 1.8 V. However, these values are dependent on the particular specific applications and the substances to be electrolyzed. For the electrolysis of carbon dioxide or another substance, these values can of course be partly significantly different.

The electrical energy converter or energy transformer serves to produce or provide an energy-technical coupling between the electrical energy source and the electrolysis cell fitted to the protective unit. The electrical energy converter, sometimes also called energy transformer, can be formed to couple the electrical energy source to the electrolysis cell in a galvanically separated manner. The energy converter serves to convert electrical energy in a first form into electrical energy of at least one second form. The energy converter can be formed to realize an energy conversion only unidirectionally. But it can therefore also be formed to realize an energy conversion at least partially or temporarily bidirectionally. Galvanically separated or potential-free here in particular means that no electrical connection to other electrical potentials needs to be present. The energy converter can be formed as an inverter or a converter as well, for example. On the electrolysis cell side, it may be formed to provide the clocked direct current with a settable amplitude and/or a settable duty cycle. In one embodiment, a current control can be realized.

But the electrical energy converter can also be formed as a hardware circuit, as a direct voltage converter or the like. The electrical energy converter can have switching elements or electronical switching elements, in particular semiconductor switches, which serve the desired conversion function. A switching element in the sense of this disclosure may be a controllable electronical switching element, for example a transistor, a thyristor, combination circuits thereof, in particular with freewheeling diodes connected in parallel, for example a metal oxide semiconductor field effect transistor (MOSFET), an insulated gate bipolar transistor (IGBT) with integrated freewheeling diodes or the like. In one embodiment, the switching element is continuously operated in the switching operation.

The switching operation of a semiconductor switch in the form of a transistor means that, when a switching state is switched on, a very low electrical resistance is provided between the terminals of the transistor forming the switching path, so that a high current flow is possible with a very low residual voltage. When the switching state is switched off, the switching path of the transistor is high ohmic, that is, it provides a high electrical resistance, so that even when the electrical voltage supplied to the switching path is high, there is substantially no or only a very low, in particular negligible, current flow. This is different from a linear operation of transistors.

According to a further development, it is proposed that an electrical cell voltage of the electrolysis cell is detected by means of a sensor unit, wherein at least one duty cycle, at least one frequency or at least one amplitude of the clocked direct current is set depending on the detected electrical cell voltage of the electrolysis cell. This makes it possible to achieve an exact individual setting for the protective current by means of the protective unit so that the non-desired fuel cell functionality can be reliably avoided. At the same time, it can be achieved that the clocked direct current is chosen so that a minimum energy effort is required in order to be able to achieve the protective effect. Overall, the protective function can thus be realized in a very energy-efficient manner. At the same time, it is possible to couple the sensor unit to the electrical energy converter and to provide, via terminal lines on the electrodes, not only the clocked direct current, but at the same time to also be able to detect the cell voltage of the electrolysis cell. This can reduce cabling efforts. This further development allows to be able to provide the protective current improved and individually for the particular electrolysis cell.

It proves to be particularly advantageous if the clocked direct current is set so that the detected electrical cell voltage of the electrolysis cell is larger than a protective voltage. The protective voltage is the voltage below which the fuel cell functionality can occur or happen. Especially due to the supply of the clocked direct current, corresponding voltage fluctuations caused by the clocked direct current can occur, which can, however, be adjusted by appropriately setting the clocked direct current so that the protective voltage is not undershot at any time.

Furthermore, it is proposed that the cell voltage is detected at least over a clock period of the clocked direct current. The cell voltage can be detected temporarily discrete at specified or specifiable times. It can be provided that the detection is only during a particular current impulse or a clock break of the particular clock period of the clocked direct current. In one embodiment, however, the detection is both during the particular current impulse and during the clock break of the particular clock period. The detection times can be chosen equidistantly. A sampling rate satisfies the Nyquist sampling theorem. In one embodiment, the sampling rate is larger than double the value of the frequency of the clocked direct current. In one embodiment, sample values of the cell voltage are quantized and digitalized. But continuous detection can also be provided. In this case, an analogous voltage signal is provided. If required, this can be digitalized for further signal processing.

Further, it is proposed that the detected electrical cell voltage and a cell current of the electrolysis cell are evaluated and a health state of the electrolysis cell is identified depending on the evaluation. This makes it possible to better consider individual changes of the electrolysis cell, for example with regard to an operating characteristic curve or the like, for setting the protective current. This can further improve reliability.

Furthermore, it is proposed that at least the duty cycle or at least the amplitude of the clocked direct current is set additionally depending on the identified health state of the electrolysis cell. This further development allows to be able to always provide the suitable protective current depending on age. In this way, the protective current can be adjusted according to the health state during the lifespan of the electrolysis cell. In total, this can further improve reliability and safety.

Further, it is proposed that for setting the duty cycle of the clocked direct current, the cell voltage is compared to an individual protective voltage of the electrolysis cell and a current impulse of the clocked direct current is triggered depending on this comparison. Thus, in this further development, no fixed frequency for the clocked direct current needs to be specified because a particular current impulse is triggered or activated respectively depending on the comparison. For example, the current impulse can then be activated for a specified duration. It can be provided that the duration of the activation of the current impulse can be set. The triggering can be, for example, in that the cell voltage is equal to the individual protective voltage or also smaller than the individual protective voltage. This functionality can be provided for every direct current impulse.

Furthermore, it is proposed that the cell voltage is compared to an individual protective voltage of the electrolysis cell and at least the amplitude, the duty cycle or the frequency of the clocked direct current is set depending on this comparison. In particular, this further development is an automated specifying of the clocked direct current. Therefore, no fixed current impulses need to be provided. This makes it possible to set the clocked direct current as advantageously as possible for protective operation. The setting can be depending on a current or a mean cell voltage. But it can also be provided that the setting is depending on a course of the cell voltage in a clock break or during a particular current impulse. Combinations hereof can also be provided. In one embodiment, the frequency is chosen to be as large as possible.

Furthermore, it is proposed that the cell voltage is compared to a specified voltage comparison value which is larger than the individual protective voltage, and a particular current impulse of the clocked direct current is terminated depending on this comparison. Thus, it is possible to set the end of a particular current impulse depending on the comparison without an outer fixed default having to be specified for this. The current impulse is terminated or deactivated as soon as it arises that the cell voltage corresponds to the specified voltage comparison value or is larger than the specified voltage comparison value. This functionality can be provided for every direct current impulse.

In one embodiment, at least the individual protective voltage or at least the voltage comparison value is identified depending on the health state. This functionality enables to realize the supply of the protective current depending on age.

According to a further development, it is proposed that the clocked direct current is overlaid with a constant direct current as the individual protective current. With the overlay, an addition can be provided, for example. Alternatively, it can also be provided that a current linking element, which can comprise a diode network, for example, only outputs the current with the higher current value. This makes it possible to realize additional setting possibilities concerning the protective function of the electrolysis cell. For example, the electrical energy converter can also be embodied in a simplified manner because the current impulse does not need to reach zero, for example. In case of an advantageous overlay, the amplitude of the constant direct current can be chosen to be significantly lower than the amplitude of the clocked direct current at the same polarity, for example in a range from 5%-25%. Thus, this low direct current proportion already causes a minimum protective voltage as a proportional pre-voltage of an electrolysis cell which is set or results below the value of the protective voltage U_{S}. Thus, a minimum voltage is provided as part of the protective voltage through the constant direct current. The combination of the clocked direct current and the constant direct current opens a flexibility of executing the protective function and the provision of a required protective voltage.

It is furthermore proposed that the frequency is constant over at least a time period which has several temporally successive periods of the clocked direct current. Thus, a reduced effort with regard to the control of the clocked direct current can be achieved. Furthermore, a stability with regard to the protective operation can be improved.

Furthermore, it is proposed that the frequency is at least about 1 Hz, preferably about 100 Hz, particularly preferably at least about 1 kHz. The frequency can also be larger than about 10 kHz. For example, it can also lie in a range of about 10 kHz to about 200 kHz. This enables to be able to achieve an amplitude of the clocked direct current that is as small as possible, which can improve, for example, effects with regard to network perturbations of an energy supply network and/or with regard to the electromagnetic tolerability.

According to a further development, it is proposed that the cell voltage is compared to a lower comparison value which is chosen so that a fuel cell functionality is reliably prevented, and to an upper comparison value which is chosen so that an electrolysis functionality is reliably prevented, wherein at least the frequency or the duty cycle is set depending on the comparisons. Preferably, the lower comparison value is larger than zero. This can create a voltage range for the cell voltage in which the cell voltage lies through corresponding setting of the clocked direct current. It can be provided that only the frequency or only the duty cycle is set. The respective other parameter can then be specified in a fixed manner, for example. Overall, a reliable operating condition can be achieved even in case of a very small difference between the lower comparison value and the upper comparison value. This is possible, for example, by choosing the frequency to be correspondingly large. Adaptations can then be achieved, as desired, by changing the duty cycle, for example. Of course, other control modes are also conceivable.

Of course, the advantages and effects indicated for the method according to the invention also equally apply for the electrolysis device according to the invention, the protective unit according to the invention and the protective apparatus according to the invention and vice versa. Insofar, method features can also be formulated as device features and vice versa.

The exemplary embodiments explained in the following are exemplary embodiments of the invention. The features, feature combinations indicated above in the description as well as the features and feature combinations mentioned in the following description of exemplary embodiments and/or shown alone in the figures can be used not only in the respective indicated combination, but also in other combinations. The invention therefore also comprises embodiments, or these are to be regarded as disclosed, which are not explicitly shown and explained in the figures, but which emerge and can be created from the explained embodiments through separate feature combinations. The features, functions and/or effects represented with the exemplary embodiments can, on their own, each represent individual features, functions and/or effects of the invention to be considered independently of one another which each can also further develop the invention independently of one another. Thus, the exemplary embodiments should also comprise other combinations than the ones in the explained embodiments. Furthermore, the described embodiments can also be complemented by further ones of the already described features, functions and/or effects of the invention.

### BRIEF DESCRIPTION OF THE DRAWINGS

In the figures, the same reference numerals indicate the same features and functions.

In the drawings:

FIG. 1 shows a schematic diagram representation of an electrolysis device with a plurality of electrolysis cells connected in series which are fitted to an electrolysis energy source and an auxiliary energy source connected in parallel;

FIG. 2 shows a schematic diagram representation of a polarization characteristic curve for an electrolysis cell of the electrolysis device according to FIG. 1 where a cell voltage of the electrolysis cell is represented depending on an electrolysis current of the electrolysis cell;

FIG. 3 shows in a schematic diagram representation like FIG. 1 an electrolysis device where a respective protective unit is connected in parallel for every single electrolysis cell;

FIG. 4 shows a schematic diagram representation which represents a clocked current as the protective current for an electrolysis cell according to FIG. 1 and a cell voltage and a control signal for the protective current by means of particular graphs;

FIG. 5 shows a schematic diagram representation of an oscillogram of a further protective current;

FIG. 6 shows a schematic diagram representation of an ageing of the electrolysis cell supplied with the protective current according to FIG. 5; and

FIG. 7 shows a schematic block diagram representation of a protective unit according to FIG. 3.

### DETAILED DESCRIPTION

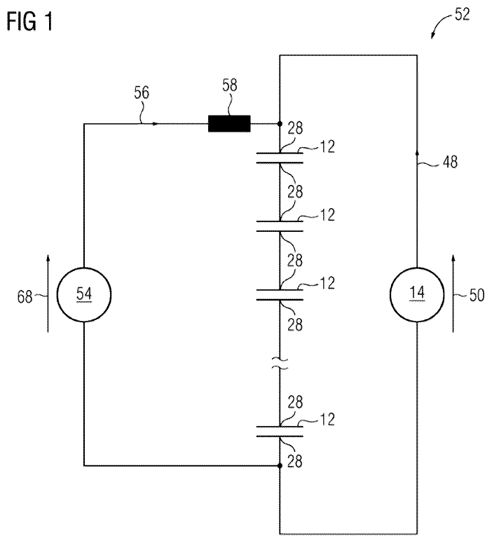

FIG. 1 shows in a schematic diagram representation an electrolysis device 52 with a plurality of electrolysis cells 12 electrically connected in series. Here, the electrolysis cells 12 serve the electrolysis of water to hydrogen and oxygen in a reaction chamber, not further represented, which is formed between particular electrodes of the particular electrolysis cell 12. Of course, in alternative designs, another substance can be subjected to electrolysis as well in order to convert it in corresponding other substances.

The electrolysis cells 12 connected in series are fitted to a main rectifier 14 as the electrolysis energy source. The main rectifier 14 provides an operating voltage 50 with which the series connection of the electrolysis cells 12 is supplied so that in normal operation, i.e. electrolysis operation, an electrolysis current 48 flows through the electrolysis cells 12.

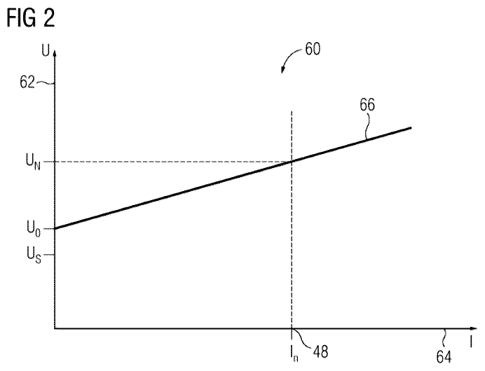

In parallel to the main rectifier 14, a series connection of a polarization rectifier 54 and a protective inductance 58 as an auxiliary energy source is connected to the series connection of the electrolysis cells 12. The polarization rectifier 54 and the protective inductance 58 serve to supply the electrolysis cells 12 outside the normal electrolysis operation with a rectifier voltage 68 which is chosen so that a protective current 56 is set, which, again, is chosen so that all electrolysis cells 12 are supplied at least with a polarization voltage U₀ (FIG. 2) as the protective voltage U_{S}. This is to avoid unwanted processes in the electrolysis cells 12 outside the normal electrolysis operation.

FIG. 2 shows in a schematic diagram representation a diagram 60 where an ordinate 62 of a cell voltage on particular cell terminals 28 is assigned to a single one of the electrolysis cells 12. An abscissa 64 is assigned to the corresponding cell current of this electrolysis cell 12. A graph 66 represents the dependency of the cell voltage from the cell current. U_{N} indicates an electrolysis voltage which sets on the electrolysis cell 12 in normal electrolysis operation when the electrolysis cell 12 is supplied with the electrolysis current 48. An intersection of the graph 66 with the ordinate 62 defines the polarization voltage U₀ whose shortfall can result in a polarization change of the cell current.

In the present design of the electrolysis cell for the electrolysis of water, the electrolysis voltage U_{N} is about 1.8 to 1.9 V. The polarization voltage U₀ can be about 1.48 V in the present design. Depending on a construction of the electrolysis cells 12, the polarization voltage U₀ can also lie in a range from about 1.25 V to about 1.45 V. In case of a cell voltage which is larger than about 1.48 V, the electrolysis cell 12 starts the electrolysis functionality by creating both hydrogen and oxygen.

Thus, the electrolysis device 52 according to FIG. 1 proves to be disadvantageous in that there can still be gas production outside the actual electrolysis process or the normal electrolysis operation. This can result in undefined conditions in the electrolysis device 52 which, in the most disadvantageous case, can even lead to the creation of an inflammable gas mixture. In order to guarantee safety here, additional extensive protective measures are required.

Furthermore, particularly when starting up the electrolysis device 52 or when shutting down the electrolysis device 52, the case can occur that one or more of the electrolysis cells 12 fall below the polarization voltage U₀ due to an uneven distribution of a protective voltage U_{S} across the electrolysis cells 12 connected in series. This problem can occur, among other things, because the electrolysis cells 12 are not all identical and/or have a different health state. This can result in an undesired fuel cell operation which can damage the particular electrolysis cells 12.

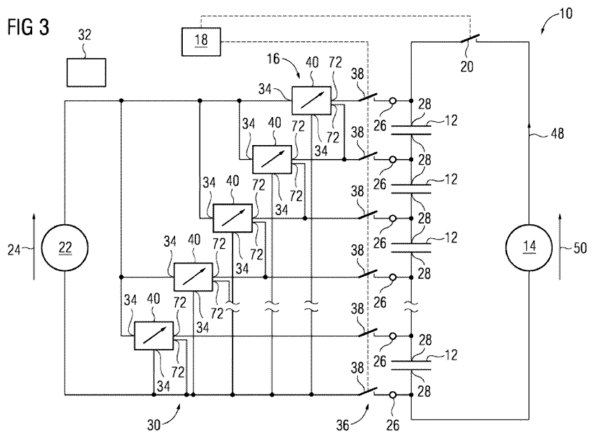

FIG. 3 now shows an electrolysis device 10 where the above-stated problems can be reduced or even avoided completely. The electrolysis device 10 is based on the electrolysis device 52 according to FIG. 1; thus, additional reference is made to the respective explanations. Here as well, a series connection of a plurality of electrolysis cells 12 is provided, which is fitted to the main rectifier 14 in parallel in order to be supplied with electrical energy in normal electrolysis operation. Insofar, the electrolysis device 10 corresponds to the electrolysis device 52, thus, reference is made to the respective explanations for FIGS. 1 and 2.

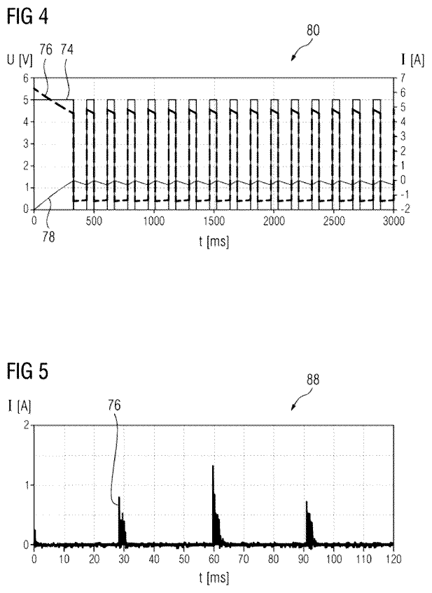

In contrast to the design according to FIG. 1, it is provided for the electrolysis device 10 according to FIG. 3 that it has a protective apparatus 16 which serves the provision of an individual protective current 76 (see FIG. 4) for each one of the electrolysis cells 12 connected in series. The protective apparatus 16 is fitted to the electrolysis cells 12, namely to their cell terminals 28. The protective apparatus 16 has an electrical auxiliary voltage source 22 as an electrical energy source which serves to provide an electrical auxiliary direct voltage 24. Further, the protective apparatus 16 has terminal fittings 26 for electrically connecting to the cell terminals 28 of the electrolysis cells 12 of the series connection. Thus, in the present design, it is provided that all cell terminals 28 are electrically coupled to the protective apparatus 16.

The protective apparatus 16 further has particular protective units 40 with terminals 72 which are electrically coupled to a particular one of the electrolysis cells 12, i.e. their electrodes, respectively via the terminal fittings 26 and the cell terminals 28. Furthermore, the protective units 40 each have two connection terminals 34 by means of which they can be electrically coupled to the auxiliary voltage source 22. This makes it possible to individually supply each one of the electrolysis cells 12 with a protective current 76 in order to be able to also reliably reach a larger cell voltage than the polarization voltage U₀ independent of normal operation.

For example, the electrical auxiliary voltage source 22 can be electrically coupled to a public energy supply network or the like. Every protective unit 40 provides an individual protective current 76 for the particular one of the electrolysis cells 12 so that a respective individual protective voltage U_{S} for an electrolysis cell 12 can be achieved.

The particular protective voltage U_{S} (see FIG. 2) is chosen so that no fuel cell effect is developed on any of the electrolysis cells 12, i.e. gas residues react to form water in a particular electrolysis cell 12 according to the fuel cell principle and thus release energy. This can lead to a significant aging of a particular electrolysis cell 12.

The protective apparatus 16 further has a switching unit 36 which is fitted to the terminals 72 of the protective units 40 and to the terminal fittings 26. The switching unit 36 is not necessarily required for the invention and can—as required—also be omitted or be formed in a modified manner. In the present design, the switching unit 36 is formed to electrically couple the protective units 40 for providing an individual protective current 76 to the terminals 72 depending on a switching state of the switching unit 36 with the terminal fittings 26. Thus, the possibility is created that the protective units 40 only need to be electrically connected to the electrolysis cells 12 if this is required or desired due to the operating situation of the electrolysis device 10. Thus, the protective units 40 can also be deactivated by means of the switching unit 36 relative to the electrolysis cells 12 if the electrolysis cells 12 are operated in the electrolysis operation as intended. Then, the switching state of a corresponding individual switching element 38 of the switching unit 36 is open. Furthermore, it can be provided, for example that the voltage sensors 44 of the protective units 40 are directly fitted to the terminal fittings 26 for a detection of the cell voltages if it is desired that the cell voltages should be able to be detected independent of the switching state of the switching unit 36.

The switching unit 36 has a respective individual switching element 38 for each one of the terminal fittings 26, which is formed by a reed relay or reed contact here. Of course, in alternative designs, a corresponding relay or a contactor or also an electronic switching element can also be provided here.

The switching elements 38 are commonly controlled by a control unit 18 of the electrolysis device 10 with regard to their particular switching state so that all of the switching elements 38 substantially assume the same switching state. For this purpose, the control unit 18 can comprise a control circuit which, among others, also serves to control the protective apparatus 16.

In order to control the switching unit 36, it is provided in the present design that a cell current of the series connection of the electrolysis cells 12 is detected as a sensor unit by means of a current sensor 46. The current sensor 46 delivers a corresponding sensor signal to the control unit 18 which evaluates this signal. As soon as the sensor signal is smaller than a specified comparison value, the switching unit 36 is switched from the switched-off switching state to the switched-on switching state. This means that through the protective apparatus 16, which is hereby now activated, every electrolysis cell 12 is supplied with the corresponding individual protective current 76.

Here, the protective units 40 are formed identically. However, if required, this can also be different. One of the protective units 40 is explained as an example with a schematic block diagram representation according to FIG. 7. In order to provide the protective current 76, the protective unit 40 has an electronic voltage converter 42 coupled to the electrical auxiliary voltage source 22 which is here formed as a galvanically separating DC/DC converter. At the same time, the voltage converter 42 is formed to deliver the specifiable protective current 76 depending on a control signal. For this purpose, the voltage converter 42 is fitted to a control unit 32 of the protective apparatus 16 via an interface terminal 70. Among others, the control unit 32 provides the corresponding control signal so that the electrolysis cell 12 coupled to the protective unit 40 can be supplied with the individual protective current 76.

Furthermore, the protective unit 40 has a voltage sensor 44 fitted to the terminals 72 with which the cell voltage of the electrolysis cell 12 can be detected. A corresponding sensor signal is transmitted from the voltage sensor 44 to the control unit 32 via the interface terminal 70. The control unit 32 evaluates the sensor signal, among others, and identifies a protective current 76 to be set depending thereon. The control signal is transmitted to the voltage converter 42 depending on the identified protective current 76.

Here, it is provided that the protective units 40 of the protective apparatus 16 are all formed identically and can be controlled by means of the protective unit 32.

FIG. 4 exemplarily shows, in a schematic diagram representation for one of the electrolysis cells 12 according to FIG. 3, a protective current 76 for the protective unit 40 coupled to the particular electrolysis cell 12. In the diagram 80 represented in FIG. 4, a left ordinate is assigned to the electrical voltage in V and a right ordinate is assigned to the electrical current in A. An abscissa is assigned to a time axis in ms. A graph 74 represents a converter-internal converter control signal 74 of the voltage converter 42 which controls the delivery of the protective current 76. Here, the converter control signal 74 is a rectangular signal so that the voltage converter 42 is able to provide a clocked direct current. The clocked direct current, which represents the protective current 76, is represented by means of a corresponding graph 76—in dotted line. It can be seen that the protective current 76 is switched on or off synchronously to the converter control signal 74.

During this operation, the cell voltage of the electrolysis cell 12 is detected by means of the voltage sensor 44. For this, no separate lines need to be provided here, as has already been explained with FIG. 7. It can be seen that the electrolysis cell 12 shows a direct voltage 78 fluctuating by a small amount as a cell voltage due to the clocked direct current as the protective current 76. Here, the voltage fluctuation is in a range from about 1.25 V to about 1.35 V. The voltage course according to graph 78 results due to the capacitive effect of the electrolysis cell 12. This also explains why according to graph 76 during a particular duration of a particular direct current impulse, the amplitude is not constant, but falls slightly. This is also a reaction due to the capacitive characteristic of the electrolysis cell 12.

An amplitude of the clocked direct current and a duty cycle of the clocked direct current can be set with the control signal of the control unit 32 as required. For this purpose, the control unit 32 can make a corresponding evaluation of the sensor signal of the voltage sensor 44. In any case, the amplitude and the duty cycle of the clocked direct current are determined so that the detected electrical cell voltage of the electrolysis cell 12 is larger than the corresponding associated protective voltage. Furthermore, by taking into account the cell voltage and the cell current of the electrolysis cell 12 caused by the clocked direct current as the protective current, a health state of the electrolysis cell 12 can be identified depending on an evaluation. The duty cycle and/or the amplitude of the clocked direct current can then be set additionally depending on the identified health state of the electrolysis cell 12.

In an alternative design, it can be provided that a regulation can be realized using the sensor signal of the voltage sensor 44. For this purpose, it can be provided that for setting the duty cycle of the clocked direct current, the cell voltage is compared to an individual protective voltage U_{S} (cf. FIG. 2) of the electrolysis cell 12 and a particular current impulse of the clocked direct current is triggered depending on this comparison. The cell voltage can then be compared with a specified voltage comparison value which is larger than the individual protective voltage U_{S} and the current impulse of the clocked direct current can be terminated depending on this comparison. Thus, by choosing the specified voltage comparison value, a duty cycle and/or also a frequency of the clocked direct current can be set.

Furthermore, it can be provided in an alternative or further improved design of the protective function that the clocked direct current is additionally overlaid with a constant direct current as the individual protective current 76. Thus, it can be achieved, for example, that the protective current does not reach the value zero. This can improve reliability and safety. In case of such an advantageous overlay, the constant direct current can be chosen to be significantly lower than the amplitude of the clocked direct current at the same polarity, for example in a range from 10%-25%, typically about 15%. Thus, this low direct current proportion already causes a minimum protective voltage as a proportional pre-voltage of an electrolysis cell which is set below the value of the protective voltage U_{S} or results corresponding to the amplitude of the constant direct current. The combination of the clocked direct current and the constant direct current opens a flexibility of executing the protective function and the provision of the protective voltage U_{S}.

FIG. 5 shows an oscillogram 88 of a further protective current in a further schematic diagram representation. Again, the protective current 76 is represented with a corresponding graph 76. An abscissa is assigned to time in ms, whereas an ordinate is assigned to a current in A. It can be seen that in this design, the clocked direct current has current impulses in a range between 0.5 and 1.5 A. Here, the current impulses are spaced apart over a particular time period which is about 145 ms.

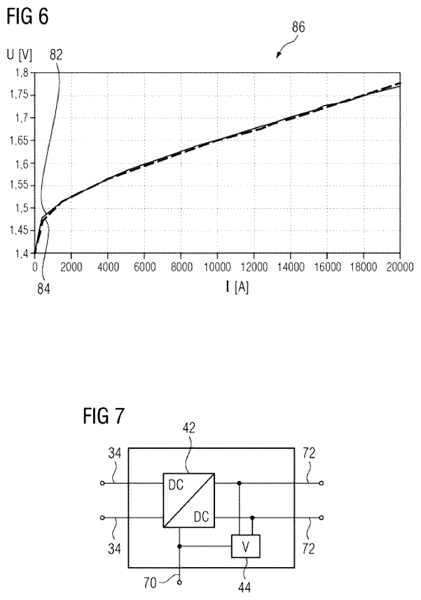

FIG. 6 shows in a further schematic diagram representation a diagram 86 with which it can be seen how the clocked protective current affects an ageing of the electrolysis cell 12. An abscissa is assigned to the electrical current in A, whereas an ordinate is assigned to the electrical voltage in V. A graph 84 represents a so-called polarization curve of an electrolysis cell 12 at the beginning of the supply of a protective current according to FIG. 5. A graph 82 represents a further polarization curve at the end of an inspection period. The inspection was carried out on an electrolysis cell 12 with an electrode surface of about 10 cm² with a current feed over a time period of 166 hours as the inspection time period with a protective current of not more than about 1.3 A. It can be seen with graphs 84 and 82 that there were no significant differences with regard to the polarization curve. It can be inferred therefrom that no measurable aging of the fuel cell 12 has taken place.

The frequency of the clocked direct current can be chosen in a range from about 10 Hz to about 100 Hz. In one embodiment, it is in a range of about 30 Hz.

The exemplary embodiments exclusively serve to explain the invention and are not intended to limit it.

1. A method for operating an electrolysis cell, to which an electrical electrolysis current is supplied in normal operation, in order to carry out an electrolysis of a substance arranged in a reaction chamber of the electrolysis cell, a direct current being supplied as individual protective current to the electrolysis cell in an operating state different from normal operation, wherein a clocked direct current is supplied to the electrolysis cell as the individual protective current.

2. The method according to claim 1, wherein an electrical cell voltage of the electrolysis cell is detected by means of a sensor unit (46), wherein at least one duty cycle, at least one frequency or at least one amplitude of the clocked direct current is set depending on the detected electrical cell voltage of the electrolysis cell.

3. The method according to claim 2, wherein the cell voltage is continuously detected at least over a clock period of the clocked direct current.

4. The method according to claim 3, wherein the detected electrical cell voltage and a cell current of the electrolysis cell are evaluated and a health state of the electrolysis cell is identified depending on the evaluation.

5. The method according to claim 4, wherein at least a duty cycle or at least an amplitude of the clocked direct current is set additionally depending on the health state of the electrolysis cell.

6. The method according to claim 1, wherein a cell voltage is compared to an individual protective voltage of the electrolysis cell and at least an amplitude or a frequency of the clocked direct current is set depending on this comparison.

7. The method according to claim 1, wherein a cell voltage is compared to a specified voltage comparison value which is larger than an individual protective voltage, and a particular current impulse of the clocked direct current is terminated depending on this comparison.

8. The method according to claim 6, wherein at least the individual protective voltage or at least a voltage comparison value is identified depending on a health state.

9. The method according to claim 1, wherein the clocked direct current is overlaid with a constant direct current as the individual protective current.

10. The method according to claim 9, wherein in case of an overlay, an amplitude of the constant direct current is set to be lower with regard to an amplitude of the clocked direct current at the same polarity so that a minimum voltage is provided as part of a protective voltage through the constant direct current.

11. The method according to claim 10, wherein an amplitude ratio of the constant direct current and the clocked direct current is set in a range from 5% to 25%.

12. The method according to claim 1, wherein a frequency of the clocked direct current is constant over at least a time period which has several temporally successive periods of the clocked direct current.

13. The method according to claim 12, wherein the frequency is at least 1 kHz.

14. The method according to claim 1, wherein a cell voltage is compared to a lower comparison value which is chosen so that a fuel cell functionality is reliably prevented, and to an upper comparison value which is chosen so that an electrolysis functionality is reliably prevented, wherein at least a frequency of the clocked direct current is set depending on the comparisons.

15. A protective unit for an electrolysis cell, wherein the electrolysis cell is formed so that it is supplied with an electrical electrolysis current in normal operation, in order to carry out an electrolysis of a substance arranged in a reaction chamber of the electrolysis cell, with:
at least two terminal fittings for electrically fitting to electrodes of the electrolysis cell,
at least two connection terminals for electrically connecting to an electrical energy source,
a controllable electrical energy converter coupled with the at least two connection terminals and the terminal fittings which is formed to supply a direct current as individual protective current to the electrolysis cell in an operating state different from normal operation, wherein the energy converter is formed to supply a clocked direct current to the electrolysis cell as the individual protective current.

16. A protective apparatus for an electrolysis device having a plurality of electrolysis cells electrically connected in series, with:
a plurality of protective units, wherein each of the electrolysis cells is electrically coupled with a respective protective unit,
at least one electrical energy source for supplying the protective units with electrical energy, and
a control unit for individually controlling the protective units, wherein the protective units are formed according to claim 15.

17. An electrolysis device with a plurality of electrolysis cells electrically connected in series and a protective apparatus electrically coupled with the electrolysis cells, wherein the protective apparatus is formed according to claim 16.
